(19) United States
(12) Patent Application Publication
(10) Pub. No.: US 2025/0222622 A1
(43) Pub. Date: Jul. 10, 2025

(54) MOLD APPARATUS AND MOLD SYSTEM

(71) Applicant: B.T. innovation GmbH, Magdeburg (DE)

(72) Inventor: Bernd SCHREYER, Reilingen (DE)

(21) Appl. No.: 18/853,805

(22) PCT Filed: Apr. 4, 2022
(86) PCT No.: PCT/EP2022/058890

§ 371 Date: Oct. 3, 2024

(51) Int. Cl. B28B 7/00

(52) U.S. Cl. CPC B28B 7/002

(57) ABSTRACT

A mold apparatus comprising: a mold main body which can be coupled to at least one mold portion for shaping at least portions of a cast component, at least two magnet devices which each can be transferred between an interaction position in which they are designed to be magnetically operatively connected to a mold support and to fix the position of the main mold body on the mold support, and a release position in which the magnetic operative connection is reduced and the mold main body can be positioned with respect to the mold support. The mold apparatus also comprises an activation device by which the at least two magnet devices can be transferred at least from the interaction position into the release position at least temporarily with a time offset.

The present invention relates to a mold apparatus and a mold system.

DE 19 814 025 A1 discloses a mold apparatus which presses the mold apparatus against a mold support by means of two magnet devices, wherein the magnet devices are magnetically operatively connected to the mold support. This allows the mold apparatus to be fixed in its position on the mold support. In order to release it, the magnetic operative connection with the mold support must be reduced.

However, this requires each magnet device to be individually released from the mold support. This increases the amount of work.

It is therefore the object of the present invention to provide a mold apparatus in which the release of the magnet devices can be easily carried out.

This object is achieved by a mold apparatus according to claim 1. Preferred embodiments are indicated in the sub-claims.

According to a first aspect, a mold apparatus is provided, comprising: a mold main body which can be coupled to at least one mold portion for shaping at least portions of a cast component, in particular a concrete component; at least two magnet devices which each can be transferred between an interaction position, in which they are configured to be magnetically operatively connected to a mold support and to fix the position of the main mold body on the mold support, and a release position, in which the magnetic operative connection is reduced, preferably completely cancelled, and the mold main body can be positioned with respect to the mold support.

In particular differing from DE 19 814 025 Al, the mold apparatus also comprises: an activation device by means of which the at least two magnet devices can be transferred at least from the interaction position into the release position, at least temporarily, preferably completely, with a time offset.

Thus, a common activation device is provided, which transfers the magnet devices at least from the release position into the interaction position. Since the at least two magnet devices can be transferred at least temporarily with a time offset from the respective interaction position into the release position, the load on the activation device and thus on an operator can be reduced. In particular, the operator does not have to apply, as a lifting force, the full magnetic force respectively acting of both magnet devices.

Preferably, the activation device has at least one profile portion which is coupled to one of the magnet devices in order to transfer the one magnet device at least from the interaction position into the release position with respect to the other of the magnet devices.

Thus, the time offset can be set by the profile portion, that is, the profiling thereof. In particular, the magnetic device can be mechanically transferred from the interaction position into the release position.

It is advantageous that the one magnet device is movably coupled with respect to the activation device, particularly the profile portion. For example, the one magnet device can slide and/or roll with respect to the profile portion.

It is further advantageous that the activation device has at least two profile portions and the at least two magnet devices are each coupled to a profile portion in order to transfer the respective magnet device with the profile portion at least from the interaction position into the release position.

This can further increase the flexibility of the mold apparatus. The other magnet devices can thus also be movable with respect to the respective profile portion. This allows the course of the lifting force to be controlled individually for each magnet device.

According to yet another aspect, the mold apparatus can be configured to transfer the at least one of the at least two magnet devices at least temporarily in a translational manner, preferably essentially perpendicular to the mold support, from the interaction position into the release position.

This allows the magnetic force to be quickly reduced and the load on the operator to be further reduced. Furthermore, the transfer can be carried out easily.

Preferably, the mold apparatus has at least one guide device which is configured to guide the respective magnet device in a translational manner.

Thus, the translational transfer can be ensured even during relative movement of the magnet devices with respect to the activation device.

According to yet another aspect, the mold apparatus may be configured such that a movement of the activation device for transferring the at least two magnet devices occurs along a degree of freedom that is different from the transfer movement of the at least two magnet devices.

In this way, the installation space in the transfer direction of the magnet devices can be kept small. Furthermore, the relative movement of the magnet devices with respect to the respective profile portions can easily be provided.

In this context, it is preferred that an axis of an activation movement has at least one component perpendicular to a transfer movement direction, and in particular preferably runs essentially perpendicular to the transfer movement direction.

Thus, the configuration can be further simplified. Furthermore, the activation device can also be moved in a translational manner.

According to yet another aspect, the at least one profile portion can extend with at least one component perpendicular to a transfer movement direction of the respective magnet device. Alternatively or additionally, the at least two profile portions are arranged essentially along a direction parallel to an axis of an activation movement of the activation device.

Thus, the activation device can be configured to be compact, particularly in the transfer movement direction.

It is preferred that the at least one profile portion includes, or is preferably formed by, a guide slot, a cam or a guide rail.

The guide slot can be, in particular, an oblong hole in which the respective magnet device slides. The cam can be provided eccentrically, and is preferred in particular in the case of rotational movement of the activation device. The guide rail, like the guide slot, allows for a simple translational movement of the activation device.

According to yet another aspect, the at least one profile portion can have a transfer section which is in contact with the one magnet device during transfer from the interaction position into the release position.

Thus, the transfer section can define the transfer of the respective magnet device.

Preferably, the transfer section includes an inclined section extending in a transfer movement direction and a direction perpendicular thereto, in particular in an activation movement direction of the activation device.

The inclined section can thus define the speed of transfer, that is, the movement in the transfer movement direction with respect to a movement in the activation movement direction.

Alternatively or additionally, the transfer sections of the at least two profile portions are configured differently in an activation movement direction, preferably the respective inclined sections have a different inclination at least in portions.

This allows the time offset between the transfers of the individual magnet devices to be controlled. It is advantageous that the higher the magnetic force acting in an interaction position of the respective magnet device is, the lower the inclination of the respective profile portion ist.

According to yet another aspect, the at least one profile portion can comprise a transfer initiation section configured to initiate transfer of the magnet device from the interaction position into the release position at a different time than that of the transfer of the other magnet device, and/or a transfer end section which is configured to end the transfer from the interaction position to the release position at a different time than that of the transfer of the other magnet device.

Thus, the time offset can be controlled by the transfer initiation section and/or the transfer end section.

Preferably, the transfer initiation sections and/or transfer end sections of the at least two profile portions are offset along an activation movement direction with respect to a specific amount of movement.

This makes it easy to implement the time offset. An amount of movement is, for example, a distance in the case of translational movement of the activation device or a rotation angle in the case of rotational movement.

Preferably, the at least one profile portion includes an idle section configured to be moved relative to the respective magnet device without transferring the magnet device. Thus, the activation device can be moved to transfer the other magnet device without affecting the transfer of the one magnet device. In particular, the idle section can be connected upstream of the transfer initiation section and/or downstream of the transfer end section, and can be formed continuously therewith.

According to yet another aspect, the mold main body can comprise a housing which accommodates the activation device, in particular the at least one profile portion thereof, and/or the at least two magnet devices, in each case at least partially, and is preferably arranged such that, in the interaction position of the at least two magnet devices, a pressing force is transmitted from the at least two magnet devices to the housing, in particular preferably via the activation device.

In this way, the activation device and/or the magnet devices can be protected. Furthermore, the mold main body can be pressed against the mold support.

According to yet another aspect, the mold apparatus can comprise the mold portion which is configured to come into contact with the cast component.

Thus, the shape of the cast component can be determined via the mold portion.

Preferably, the at least one mold portion is arranged in the interaction position of the at least two magnet devices so as to be movable between a mold position, in which the mold portion is configured to define an external dimension of the component at least in portions, and a removal position, in which the component can be removed from the mold portion.

Thus, the mold main body can be positioned while the mold portion is movable. This facilitates the removal of the cast component. In particular, the removal of the component can induce the movement of the mold portion from the mold position to the interaction position.

Preferably, the at least one mold portion is arranged to be movable between the mold position and the removal position, at least with one component in a direction pointing perpendicularly away from the component and, preferably, parallel to the mold support, preferably arranged to be rotatable about a pivot axis.

This can further facilitate the removal of the component. The rotational movement can allow the movement away with respect to the extension direction of the mold portion.

According to yet another aspect, the mold apparatus can further comprise biasing means, for example additional weights, which are configured to bias the at least one mold portion in the direction of the mold position.

Thus, the mold portion can be reliably held in the mold position. For example, the mold portion can be pressed against a base, wherein it can be reliably sealed against the concreting pressure.

It is also advantageous if the mold apparatus has at least one stop, which is preferably configured to be elastic, in order to define the mold position of the mold portion.

Thus, the mold position can be repeatably taken.

According to yet another aspect, a mold system may be provided, comprising at least one mold apparatus according to one of the preceding aspects, wherein the mold apparatus is arranged such that the at least one mold portion is biased by a gravitational force in the direction of the mold position.

Thus, the mold position can be created particularly easily repeatably. In particular, the at least one mold portion can extend at least in the mold position at least in portions in a vertical direction, and preferably the at least one mold portion can be arranged between the mold position and the removal position so as to be movable at least with one component perpendicularly away with respect to the vertical direction and parallel to the mold support.

The above aspects of the invention will be illustrated below with reference to the attached drawings.

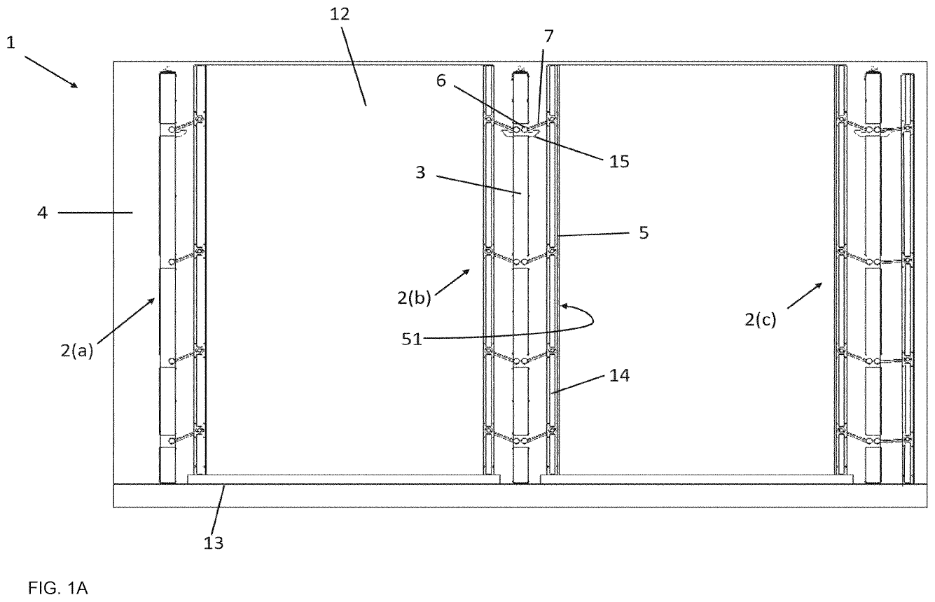

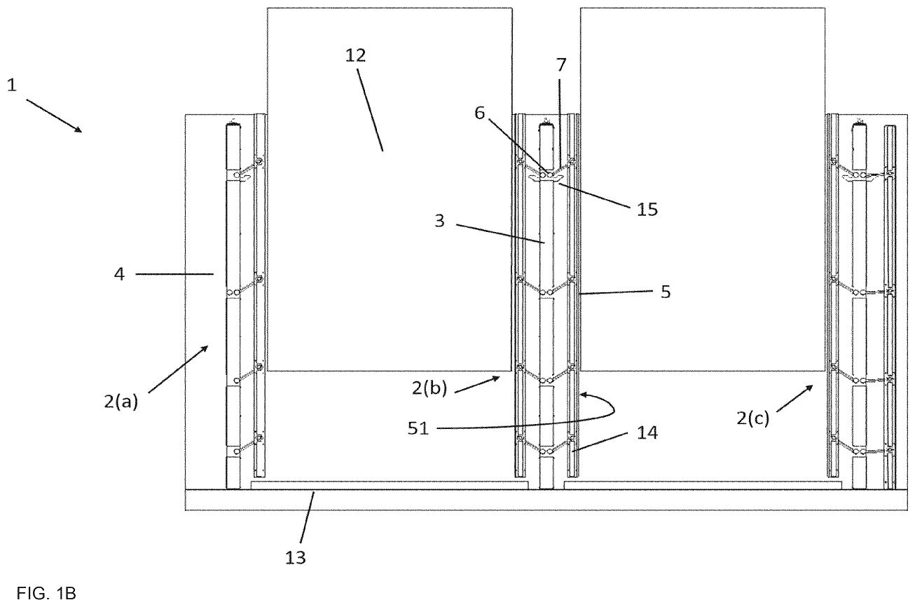

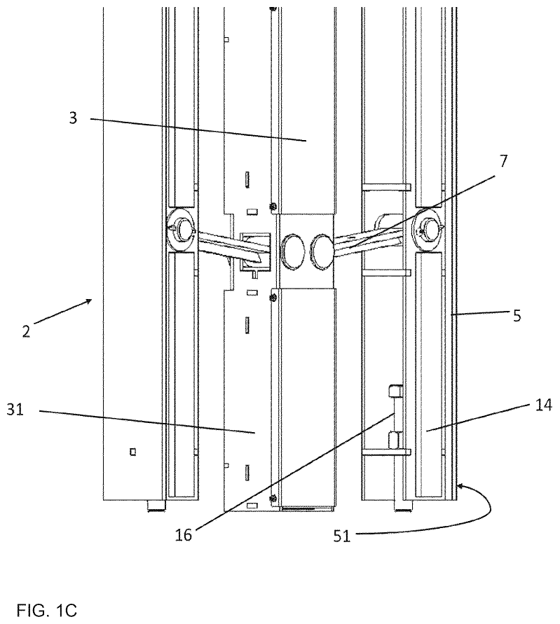

FIG. 1A shows a mold system in a front view, wherein the mold portions are in a mold position;

FIG. 1B shows the mold system, wherein the mold portions are in a removal position;

FIG. 1C shows a perspective detailed view of a mold apparatus on a side close to a base;

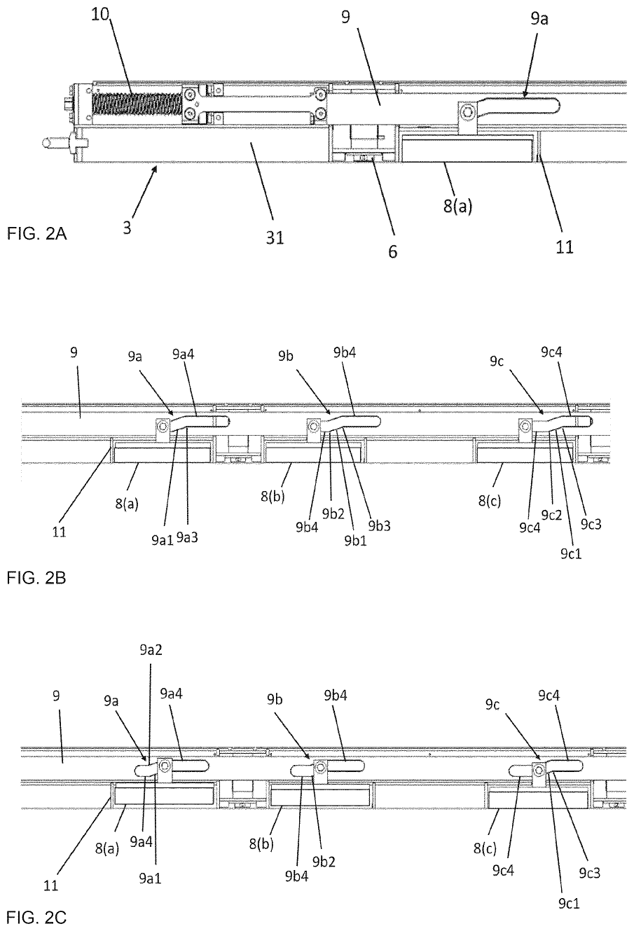

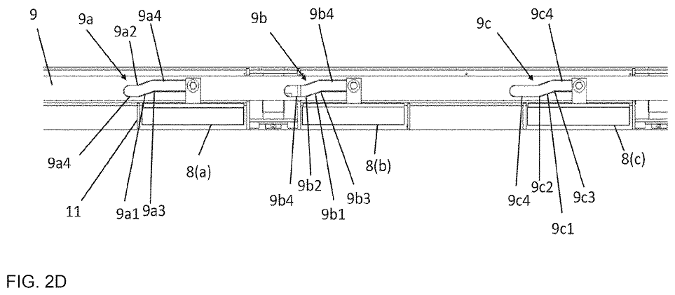

FIG. 2A shows a partial longitudinal section through the mold apparatus on a side facing away from the base;

FIG. 2B shows a partial longitudinal section through the mold apparatus, wherein the magnet devices are all in the interaction position;

FIG. 2C shows a partial longitudinal section through the mold apparatus, wherein the magnet devices are in an intermediate position; and

FIG. 2D shows a partial longitudinal section through the mold apparatus, wherein the magnet devices are in a release position.

FIGS. 1A and 1B show a mold system 1 according to the invention in a front view. The mold system 1 is configured as a vertical mold system. The mold system 1 comprises a plurality of mold apparatuses 2 (three in the example shown). The three mold apparatuses 2a, 2b, 2c are each configured as vertical mold apparatuses and are arranged parallel to one another in the transverse direction. A component 12 can be cast between the mold apparatuses 2a and 2b and 2b and 2c.

Each of the vertical mold apparatuses 2a, 2b, 2c extends essentially in the vertical direction (direction of gravity). Each mold apparatus 2a, 2b, 2c is essentially constructed in the same way, which is why only one example will be considered below. The mold apparatus 2 has a mold main body 3. The mold main body 3 is essentially box-shaped and extends essentially in the vertical direction. In cross-section, the mold main body 3 can have a shape that is open toward the side of a mold support 4. For example, the mold main body 3 can have a U-shape in cross-section. The mold main body 3 is preferably made of a material that includes or is formed from a metal, in particular a non-magnetic metal. This can be light metals such as aluminum, steel or metal alloys.

The mold apparatus 2 further comprises at least one mold portion 5. The mold portion includes a mold surface 51 configured to provide a shape for the component 12 to be cast. The mold portion 5, in particular the mold surface 51 thereof, also extends substantially in the vertical direction. The mold surface 51 is substantially perpendicular to the mold support 4. At least the mold surface is preferably made of metal, in particular steel, preferably ground stell, in order to give the component 12 a suitable surface quality. However, the mold portion 5 can also comprise a receiving portion, for example made of metal, and a mold element, for example made of wood, which comprises the mold surface and can be coupled to the receiving portion.

It is to be noted that the mold apparatus 2a comprises a mold portion 5 on a side close to the component in the transverse direction with respect to the mold main body 3. The mold apparatuses 2b and 2c each comprise a mold portion 5 on both sides in the transverse direction. Thus, the mold apparatuses 2b and 2c can each define two components 12 with respect to their outer shape.

The mold portion 5 is movably attached to the mold main body 3. The mold main body is provided with bolts 6, each of which defines a pivot axis. The mold portion 5 is thus rotatably attached to the mold main body 4 via the pivot axes. In particular, booms 7 are rotatably provided on the bolts, which in turn are hinged to the mold portion. These booms 7 form a parallelogram mechanism which allows the mold portion 5 to be moved rotationally with constant alignment, here in the vertical direction, with respect to the mold main body 3. It is preferred when the mold portion 5 can be moved with constant alignment, in particular via the parallelogram mechanism.

In FIGS. 1A and 1B, the position of the mold main body 3 is fixed on the mold support 4. However, the respective mold portions 5 are movable, as described. FIG. 1A shows the mold portions 5 in a mold position in which the component 12 can be cast. In the mold position, the mold portion 3 is in contact with a base 13. As shown in FIGS. 1A and 1B, the mold portion 3 includes flat irons 14 on a side facing away from the mold support 4. These flat irons 14 form additional weight. Since the mold system 1 is configured as a vertical mold system, the mold portions are essentially pivotable about a horizontal pivot axis (the pivot axis being perpendicular to the mold support 4). The mold position is thus taken by the force of gravity.

FIG. 1B shows the respective mold portions 5 in the removal position. In this case, the mold portions are retracted from component 12 with respect to the mold position. The removal position can be caused by removing the component 12 itself. If the component is removed in a vertical direction, a frictional force acts on the mold surface 51, which induces the rotational movement of the mold portion.

Furthermore, the mold apparatus 2 comprises at least one stop 15, such as a cushion. This stop 15 essentially defines the mold position. The stop is configured to come into contact with the boom 7. The stop can be flexible and, for example, comprise an elastomer material.

Furthermore, as can be seen in FIG. 1C, the mold apparatus 3 comprises setting means 16 which allow the mold position to be set. The mold position, as shown in FIG. 1C, can include a screw and an internal thread provided on the mold portion. Thus, the screw can function as a lifting screw that can lift the mold portion 3 off the base 13.

In order to fix the mold main body 3 in position on the mold support 4, a plurality of magnet devices 8 are provided inside the mold main body 3, as can be seen in FIGS. 2A to 2D. The mold main body 3 comprises a housing 31 (FIG. 1C, FIG. 2A) which surrounds the magnet devices 8. The housing 31 surrounds the magnet devices at least from a side facing away from the mold support 4 and on the sides facing the component 12 (mold portion).

The magnet devices 8 are preferably arranged along the extension direction of the mold main body 3. The magnet device 8 can, for example, be a magnet packet which consists of at least one magnetic material and, furthermore, preferably comprises ferromagnetic reinforcing elements.

FIG. 2B shows the magnet devices 8 in an interaction position with respect to the mold support 4. The interaction position is a position of the magnet devices 8 that is closest to the mold support 4. In this case, a magnetic operative connection is formed with the preferably ferromagnetic mold support 4. This magnetic operative connection is accompanied by a magnetic force onto the magnet devices 8 towards the mold support 4. This magnetic force is transmitted to the mold main body and can thus press the mold main body 3 onto the mold support 4 as a pressing force and thus fix its position.

Furthermore, an activation device 9 is provided inside the housing 31. The activation device 9 can transfer the magnet devices 8 from the respective interaction position into a release position. In the release position, the effective magnetic force is reduced with respect to the interaction position.

The activation device 9 extends essentially in the vertical direction. It is preferred when the activation device 9 extends parallel to the extension direction of the mold main body 3 and/or the arrangement direction of the magnet devices 8.

The activation device 9 is coupled to an operating device 10 (FIG. 2A), such as a screw, in order to be operated. An internal thread is formed in the activation device, which is coupled to the screw. The activation device 9 is also coupled to the magnet devices 8 in order to transfer these from the interaction position into the release position.

The activation device comprises profile portions 9a, 9b, and 9c (FIGS. 2B to 2D), which are each coupled in a form-fitting manner to a magnet device 8. The profile portions 9a, 9b and 9c are provided along the arrangement direction of the magnet devices 8 and each extend substantially along the arrangement direction.

Each profile portion 9a, 9b and 9c comprises a transfer section 9a1, 9b1 and 9cl having an inclination. The transfer section 9a1, 9b1 and 9cl has a transfer initiation section 9a2, 9b2 and 9c2, as well as a transfer end section 9a3, 9b3 and 9c3. The profile portions 9a, 9b and 9c are configured here as oblong holes.

The activation device 9 is configured to be moved in an activation movement direction which preferably coincides with the arrangement direction of the magnet devices. For this purpose, an activation guide device can be provided which guides the activation device along the activation movement direction. The activation movement direction runs parallel to an axis of the activation movement.

The magnet devices 8 are arranged to be transferred in a translational manner from the interaction position into the release position perpendicularly away from the mold support 4 (along a transfer movement direction). For this purpose, the mold apparatus 2 comprises a guide device 11 that guides the translational movement of the magnet devices 11. In particular, the guide device can comprise a guide slot.

The function and effects of the present invention are described below.

In order to activate the activation device and start the transfer of the magnet devices 8, an operator can operate the operating device 10. In particular, the screw allows for a torque-controlled operation. Via the internal thread, the activation device is moved, due to the translational guide, in a translational manner along the axial direction of the screw in the activation movement direction, which runs parallel to the mold support 4, that is, transversal to the vertical direction.

In this case, the profile portions 9a, 9b and 9c move in the activation movement direction. The profile portions 9a, 9b and 9c respectively move relatively to the magnet devices 8. In the activation movement direction, the transfer initiation section 9a2, 9b2, 9c2 is located in each case upstream of the transfer end section 9a3, 9b3 and 9c3. Furthermore, the transfer initiation sections 9a2, 9b2 and 9c2 are provided offset with respect to an amount of displacement of the activation device.

The profile portions 9a, 9b, and 9c extend over their entire length with a component perpendicular to the transfer movement direction, that is, with a component in the activation movement direction, that is, parallel to the mold support 4. The transfer sections 9a1, 9b1, and 9cl also extend with a component in the transfer movement direction.

In detail, the transfer initiation section 9a2 first comes into engagement with the magnet device 8a and initiates its transfer. As the activation device moves further, the magnet device 8a moves relatively in the inclined section of the transfer section 9a1, while the magnet device 8b is moved relatively in an idle section 9b4 and finally comes into engagement with the transfer initiation section 9b2. Meanwhile, the magnet device 8c moves in an idle section 9c4. As the activation device continues to move, the magnet device 8a reaches the transfer end section 9a3 while the magnet device 8b is moving in the inclined section of the transfer section 9b1, and the magnet device 8c comes into engagement with the transfer initiation section 9c2 (FIG. 2C). Then, magnet device 8a moves in an idle section 9a4, magnet device 8b comes into engagement with the transfer end section 9b3, and magnet device 8c moves in the inclined section of the transfer section 9c1. Finally, magnet devices 8a and 8b each move in the idle sections 9a4 and 9b4, while magnet device 8c comes into engagement with the transfer end section 9c3 and is then also moved in the idle section 9c4, which is connected downstream of the transfer end section 9c3 (FIG. 2D).

Due to the inclination of the transfer sections, the magnet devices 8 are moved away from the mold support 4 and continuously transferred into the release position.

According to the above embodiment, each of the mold apparatuses 2 comprises the one activation device 9 which is configured to transfer the magnet devices 8 at least from the interaction position into the release position, wherein the activation device 9 is configured to transfer the magnet devices 8 at least temporarily, preferably completely, with a time offset from the interaction position into the release position.

Thus, a common activation device 9 is provided, which transfers the magnet devices 8 at least from the release position into the interaction position. In particular, the activation device 9 moves as a unit. Since the magnet devices 8 can be transferred from the respective interaction position into the release position at least temporarily with a time offset by means of the profile portions 9a, 9b and 9c, the load on the activation device 9 and thus on an operator can be reduced. In particular, the operator does not have to apply, as a lifting force, the full magnetic force of both magnet devices. For example, the magnetic force of the magnet device 8a is already reduced when the magnet devices 8b and 8c are moved from their respective interaction position to the release position.

The activation device comprises the profile portions 9a, 9b and 9c, which are each coupled to one of the magnet devices 8a, 8b and 8c, in order to transfer the magnet devices 8a, 8b and 8c at least from the interaction position into the release position.

Thus, the time offset can be set by the respective profile portion 9a, 9b and 9c, that is, the profiling thereof. This can further increase the flexibility of the mold apparatus. In particular, the course of the lifting force can be controlled individually for each magnet device 8a, 8b and 8c.

The magnet devices 8a, 8b and 8c are movably coupled with respect to the activation device 9, in particular the profile portions 9a, 9b and 9c. The magnet devices 8a, 8b and 8c can slide and/or roll with respect to the profile portions 9a, 9b and 9c.

In particular, the magnet devices 8a, 8b and 8c can be mechanically transferred from the interaction position into the release position.

Furthermore, the magnet devices 8a, 8b and 8c are arranged to be transferred, at least temporarily, in a translational manner, preferably essentially perpendicular to the mold support 4, from the interaction position into the release position.

This allows the magnetic force to be quickly reduced and the load on the operator to be further reduced. Furthermore, the transfer can be carried out easily.

Preferably, the mold apparatus 2 has at least one guide device 11, which is configured to guide the respective magnet device 8a, 8b and 8c in a translational manner.

Thus, the translational transfer can be ensured even during relative movement of the magnet devices 8a, 8b and 8c with respect to the activation device 9.

Furthermore, the activation device 9 is arranged such that a movement of the activation device 9 for transferring the magnet devices 8a, 8b and 8c (activation movement direction) occurs along a degree of freedom that is different from the transfer movement of the magnet devices 8a, 8b and 8c. This means that the installation space in the transfer direction (perpendicular to the mold support 4) of the magnet devices 8a, 8b and 8c can be kept small. Furthermore, the relative movement of the magnet devices 8a, 8b and 8c to the respective profile portions 9a, 9b and 9c can be easily provided. In this case, it is preferred that the axis of the activation movement be essentially perpendicular to the transfer movement direction. Furthermore, it is preferred that the axis of the activation movement be parallel to an arrangement direction of the magnet devices 8a, 8b and 8c, wherein the activation device 9 can be moved in a translational manner. Thus, the configuration can be further simplified.

The profile portions 9a, 9b and 9c extend at least with a component perpendicular to the transfer movement direction of the respective magnet devices 8a, 8b and 8c, in particular with a component in the activation movement direction. In addition, the profile portions 9a, 9b and 9c are arranged parallel to the axis of the activation movement. Thus, the activation device 9 can be configured to be compact in the transfer movement direction.

The profile portions 9a, 9b and 9c are each formed by a guide slot. The guide slot comprises an oblong hole in each case, in which the respective magnet device slides or rolls. The profiling of the oblong hole, that is the boundary thereof, defines the transfer of the respective magnet device 8a, 8b and 8c.

The profile portions 9a, 9b and 9c each comprise the transfer section 9a1, 9b1 and 9cl, which is in contact with the one magnet device during the transfer from the interaction position into the release position.

Thus, the transfer sections 9a1, 9b1 and 9cl can define the transfer of the respective magnet device 8a, 8b and 8c.

The transfer sections 9a1, 9b1 and 9cl comprise an inclined section which extends in a transfer movement direction and a direction perpendicular thereto, in particular in the activation movement direction.

The inclined section can thus define the speed of the transfer, that is, the movement in the transfer movement direction with respect to a movement in the activation movement direction.

The transfer sections 9a1, 9b1 and 9cl of the profile portions 9a, 9b and 9c are formed differently along the activation movement direction. In particular, the transfer initiation sections 9a2, 9b2 and 9c2 and transfer end sections 9a3, 9b3 and 9c3 of the profile portions 9a, 9b and 9c are offset along an activation movement direction with respect to a certain displacement amount.

This allows the time offset between the transfer of the individual magnet devices 8a, 8b and 8c to be controlled.

Although not shown, in the case of magnet devices with different strengths, it is advantageous that the higher the magnetic force acting in an interaction position of the respective magnet device, the lower the inclination of the respective profile portion.

The profile portions 9a, 9b and 9c each comprise at least one idle section 9a4, 9b4 and 9c4, which is configured to be moved relatively to the respective magnet device 8a, 8b and 8c without transferring the respective magnet device 8a, 8b and 8c. Thus, the activation device 9 can be moved to transfer the other magnet devices 8b and 8c without affecting the transfer of the one magnet device 8a. In particular, the idle section 9a4, 9b4 and 9c4 can be connected upstream of the transfer initiation section 9a2, 9b2 and 9c2 and/or downstream of the transfer end section 9a3, 9b3 and 9c3, and can be formed continuously therewith.

Furthermore, the mold main body 3 comprises a housing 31 which does not only accommodate the magnet devices 8a, 8b and 8c, but also the activation device 9, in particular the profile portions 9a, 9b and 9c thereof.

In addition, a pressing force is transmitted by the magnet devices 8 to the mold main body 3, in particular via the activation device 9 to the housing 31. For this purpose, the activation device can be in contact with the activation guide device in the interaction position of the magnet devices 8.

Thus, the activation device 9 and/or the magnet devices 8 can be protected. Furthermore, the mold main body 3 can be pressed against the mold support 4.

The mold apparatus 2 includes the mold portion 5, which is configured to come into contact with the component 12 to be cast.

Thus, the shape of the cast component 12 can be determined by means of the mold portion 5.

The mold portion 5 is arranged in the interaction position of the magnet devices 8 to be movable between the mold position, in which the mold portion is configured to define an outer dimension of the component 12 at least in portions, and a removal position, in which the component 12 is removable from the mold portion 5.

Thus, the mold main body 3 can be positioned while the mold portion 5 is movable. This facilitates removal of the cast component 12. In particular, removal of the component 12 can induce movement of the mold portion 5 from the mold position into the interaction position.

The mold portion 3 is movably arranged between the mold position and the removal position with a component in a direction perpendicularly away from the component 12, that is, from the extension direction of the mold portion 5 and parallel to the mold support 4. Furthermore, the movement also has a component in the extension direction of the mold portion 5, or parallel to the axis of the activation movement, which is preferably, as here, parallel to the extension direction of the mold portion 5. In other words, the movement between the mold position and the removal position occurs in a plane parallel to the mold support 4.

It is preferred that the movement also has a component other than the component pointing perpendicularly away from the extension direction of the mold portion 3, preferably a component in a direction parallel to the axis of the activation movement. This is because the mold apparatus 2 can be configured to be very compact and interference with the activation device can be suppressed.

In particular, the mold portion 5 is arranged rotationally about a pivot axis. This can further facilitate the removal of the component 12. The rotational movement can allow the movement away with respect to the extension direction of the mold portion 5.

In addition, the extension direction of the mold portion 5 remains constant during the entire movement, and in particular runs parallel to the axis of the activation movement. This further makes the configuration compact.

The mold apparatus 2, in particular the mold portion 5, has additional weights 14 which function as biasing means. The biasing means apply a force to the mold portion 5 towards the mold position, that is, towards the base 13.

Thus, the mold portion 5 can be reliably held in the mold position. The mold portion 5 can be pressed against the base 13, wherein a reliable seal can be provided against the concreting pressure.

The mold apparatus 2 further comprises the stop 15, which is preferably configured to be elastic, in order to essentially define the mold position of the mold portion 5.

Thus, the mold position can be repeatedly assumed. Furthermore, the mold portion is prevented from impacting the base 13 in an uncontrolled manner.

It is preferred that the stop 15 be provided such that when moving out of the mold position, a component is immediately provided away from the component, that is, from the extension direction of the mold portion 5. Thus, in FIG. 1A, an acute angle is provided between the direction of gravity or the extension direction of the mold portion 5 and the boom 7.

Furthermore, the mold apparatus 2 comprises the setting means 16, which allow the mold position to be set. In particular, the mold position can be set with respect to the base 13. For example, the base 13 can be changed by placing a support plate on it. The lifting screw can be used to react to such a change to the base 13.

The mold system 1 is configured such that the mold apparatuses 2a, 2b and 2c are arranged such that the at least one mold portion is biased by a gravitational force towards the mold position.

The gravitational force holds the mold portions 5 in the mold position relative to the base 13. A pressing force towards the mold support 4 can be generated, for example, by clamping in a battery mold or modular mold. Thus, mold system 1 relates in particular to working in battery molds and modular molds, in which complex component shapes can also be produced. The invention is therefore also directed to a battery mold or modular mold comprising said mold system 1.

In the mold position, the concrete is filled between the adjacent mold portions 5 of the adjacent mold apparatuses 2a and 2b as well as 2b and 2c. After hardening, the cast component 12 can be removed in a vertical direction. In this process, the rotational movement of the mold portion 5 is induced by frictional forces, which facilitates accessibility of the component 12. After the mold portions 5 have been transferred into the removal position, they fall back into the mold position under the force of gravity.

It is preferred that the axis of the activation movement be parallel to the direction of gravity and that the activation device 9 be operable on a side facing away from the base 13. Thus, operability can be facilitated.

### MODIFICATION OF THE EMBODIMENT

In the embodiment, at least one profile portion is respectively assigned to each magnet device 8a, 8b and 8c. However, it is also possible that one or two of the magnet devices 8a, 8b and 8c are integrally coupled to the activation device 9. Thus, only one profile portion can be provided for a magnet device, which controls the time offset of this magnet device with respect to the other two magnet devices.

The number of magnet devices does not have to be three, but can be two or any other plurality.

The activation movement direction and/or axis does not have to be perpendicular to the transfer movement direction. For example, the activation device can also be moved translationally perpendicular away from the mold support 4 so that the activation movement direction and its axis coincide with the transfer movement direction. Then, for example, at least for one magnet device, a profile portion can be provided that also extends in this direction and has an idle section that moves relatively to the magnet device while another magnet device moves integrally with the activation device before a transfer initiation section comes into engagement with the magnet device and lifts it.

Instead of the guide slot, a guide rail can also be provided that is profiled accordingly.

The activation device can also be moved rotatably. In this case, the activation movement direction defines a circumferential direction. However, in this case too, the activation movement direction has an axis which can be arranged as described in the embodiment. When the activation device is rotating, the profile portion can be formed by a profiled cam. For example, two cams can be provided in a circumferentially offset manner.

It is also possible that all magnet devices are transferred from their interaction position into the release position temporarily at the same time. However, it is preferred that the initiation of the transfer in particular occurs at different times. In addition, at least two magnet devices can be transferred completely synchronously as long as another magnet device is transferred at least temporarily with a time offset.

Furthermore, no profile portion needs to be provided. For example, the activation device can have several electromagnetic portions that can be activated in a timely offset manner in order to lift the respective magnet devices from the mold support 4.

In the embodiment, the mold support 4 extends in the vertical direction. However, the mold support can also extend horizontally. In this case, the mold portions and the mold main body also preferably extend in the horizontal direction. In other words, the system can be rotated by 90°. However, in this arrangement, the mold portion can also be held in the mold position by the force of gravity. For this purpose, the installation position of the bolts 6 can be rotated with respect to the embodiment so that the movement of the boom 7 takes place in a plane perpendicular to the mold support 4. The alignment of the stop 15 is also to be adjusted accordingly.

The setting means can also be provided to set the arrangement of the stop 15.

Furthermore, the mold portion can also be provided integrally with the mold main body. It does not have to be configured to be movable in relation to it. Mold portions can be provided on one or both sides of the mold main body.

1. A mold apparatus comprising:
a mold main body which can be coupled to at least one mold portion for shaping at least portions of a cast component;
at least two magnet devices which each can be transferred between an interaction position in which the at least two magnet devices are configured to be magnetically operatively connected to a mold support and to fix a position of the mold main body on the mold support, and a release position in which the magnetic operative connection is reduced and the mold main body can be positioned with respect to the mold support; and
a common activation device by which the at least two magnet devices can be transferred at least from the interaction position into the release position at least temporarily with a time offset;
wherein the common activation device comprises at least one profile portion which is coupled to a first one of the at least two magnet devices to transfer the first one of the at least two magnet devices at least from the interaction position into the release position with respect to a second one of the at least two magnet devices, wherein the time offset is set by a profiling of the at least one profile portion.

2. (canceled)

3. The mold apparatus according to claim 1, wherein the common activation device comprises at least two profile portions and the at least two magnet devices are each coupled to one of the at least two profile portions in order to transfer a respective one of the at least two magnet devices at least from the interaction position into the release position.

4. The mold apparatus according to claim 1, wherein the mold apparatus is configured to transfer at least one of the at least two magnet devices at least temporarily in a translational manner from the interaction position into the release position, and
wherein the mold apparatus has at least one guide device which is configured to guide the at least one of the at least two magnet devices in a translational manner.

5. The mold apparatus according to claim 1, wherein the mold apparatus is configured such that a movement of the common activation device for transferring the at least two magnet devices is along a degree of freedom that is different from the transfer movement of the at least two magnet devices.

6. The mold apparatus according to claim 1, wherein the at least one profile portion extends with at least one component perpendicular to a transfer movement direction of the respective magnet device; and/or
at least two profile portions are arranged essentially along a direction parallel to an axis of an activation movement of the common activation device.

7. The mold apparatus according to claim 1, wherein the at least one profile portion comprises a guide slot, a cam or a guide rail.

8. The mold apparatus according to claim 1, wherein the at least one profile portion has a transfer section which can be in contact with the first one of the at least two magnet devices during transfer from the interaction position into the release position.

9. The mold apparatus according to claim 1, wherein the at least one profile portion comprises a transfer initiation section which is configured to initiate the transfer of the first one of the at least two magnet devices from the interaction position into the release position at a different time than that of the transfer of the second one of the at least two magnet devices, and/or comprises a transfer end section which is configured to end the transfer from the interaction position into the release position at a different time than that of the transfer of the second one of the at least two magnet devices.

10. The mold apparatus according to claim 1, wherein the mold main body comprises a housing which at least partially in each case accommodates the common activation device, and is arranged such that, in the interaction position of the at least two magnet devices, a pressing force is transmitted from the at least two magnet devices to the housing.

11. The mold apparatus according to claim 1, wherein the at least one mold portion is configured to come into contact with the cast component.

12. The mold apparatus according to claim 11, wherein the at least one mold portion is movable in the interaction position of the at least two magnet devices between a mold position, in which the at least one mold portion is configured to define, at least in portions, an outer dimension of the cast component, and a removal position in which the cast component can be removed from the at least one mold portion.

13. The mold apparatus according to claim 12, wherein the at least one mold portion is arranged to be movable between the mold position and the removal position at least with one component in a direction pointing perpendicularly away from the cast component.

14. The mold apparatus according to claim 12, further comprising biasing means which are configured to bias the at least one mold portion towards the mold position.

15. A mold system comprising at least one mold apparatus according to claim 12, wherein the mold apparatus is arranged such that the at least one mold portion is biased toward the mold position by a gravitational force.
